(19) United States
(12) Patent Application Publication
(10) Pub. No.: US 2024/0233429 A1
(43) Pub. Date: Jul. 11, 2024

(54) SYSTEM AND INFORMATION PROCESSING METHOD

(71) Applicants: KABUSHIKI KAISHA TOSHIBA, Tokyo (JP); TOSHIBA INFRASTRUCTURE SYSTEMS & SOLUTIONS CORPORATION, Kawasaki-shi Kanagawa (JP)

(72) Inventor: Kazutaka Asahi, Kawasaki Kanagawa (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi Kanagawa (JP)

(21) Appl. No.: 18/616,518

(22) Filed: Mar. 26, 2024

Related U.S. Application Data
(63) Continuation of application No. PCT/JP2022/034257, filed on Sep. 13, 2022.

(30) Foreign Application Priority Data
Sep. 29, 2021 (JP) 2021-159336

(51) Int. Cl. G06V 30/26; G06V 30/148

(52) U.S. Cl. CPC G06V 30/26; G06V 30/153

(57) ABSTRACT

A system and an information processing method capable of presenting an item for which input is accepted are provided. The system according to an embodiment includes an image interface, an input/output interface, and a processor. The image interface acquires a character string image including a character string. The input/output interface is connected to an input/output device that displays an image and accepts input of an operation. The processor performs character recognition processing on the character string image, sets an item, for which input is accepted, related to the character string based on a result of the character recognition processing, displays an input screen including the character string image and item information indicating the item on the input/output device through the input/output interface, and accepts input of the item through the input/output interface.

### CROSS REFERENCE TO RELATED APPLICATIONS

This application is a Continuation Application of PCT Application No. PCT/JP2022/034257, filed Sep. 13, 2022 and based upon and claiming the benefit of priority from Japanese Patent Application No. 2021-159336, filed Sep. 29, 2021, the entire contents of all of which are incorporated herein by reference.

### FIELD

Embodiments described herein relate generally to a system and an information processing method.

### BACKGROUND

A system is provided in which a screen is acquired from an existing video coding desk (VCD) and optical character recognition (OCR) is performed on the acquired image. If OCR processing fails, such a system displays the screen from the existing VCD and accepts input from an operator for a character string.

There is a case where the system accepts input from an operator for an item (e.g., a postal code, a district, etc.) for which OCR processing has failed.

Conventionally, the system has a problem in which an item for which input is accepted cannot be presented to the operator, diminishing the typing efficiency of the operator.

### BRIEF DESCRIPTION OF THE DRAWINGS

FIG. 1 is a block diagram illustrating a configuration example of an input system according to an embodiment.

FIG. 2 is a block diagram illustrating a configuration example of an existing VCD according to the embodiment.

FIG. 3 is a block diagram illustrating a configuration example of an OCR input device according to the embodiment.

FIG. 4 is a diagram illustrating a display example of a new VCD according to the embodiment.

FIG. 5 is a diagram illustrating an example of item information according to the embodiment.

FIG. 6 is a flowchart illustrating an operation example of the OCR input device according to the embodiment.

### DETAILED DESCRIPTION

The system according to an embodiment includes an image interface, an input/output interface, and a processor. The image interface acquires a character string image including a character string. The input/output interface is connected to an input/output device that displays an image and accepts input of an operation. The processor performs character recognition processing on the character string image, sets an item, for which input is accepted, related to the character string based on a result of the character recognition processing, displays an input screen including the character string image and item information indicating the item on the input/output device through the input/output interface, and accepts input of the item through the input/output interface.

Hereinafter, embodiments will be described with reference to the drawings.

An input system according to the embodiment acquires an image including a character string such as a postal code from an existing VCD. The input system performs OCR processing (character recognition processing) on the acquired image in an OCR input device. The input system inputs, to the existing VCD, an operation signal for inputting the character string based on a result of the OCR processing. If the OCR processing fails, the input system displays the acquired image on the OCR input device. The input system accepts input of a key from an operator through a new VCD and the OCR input device. The input system supplies an operation signal for inputting the key from the OCR input device to the new VCD.

Here, the input system displays, on the new VCD, an image (destination image, character string image) of a mail item in which a character string related to a destination such as a postal code is written, and accepts input from the operator for an item related to the destination of the mail item. Furthermore, the input system displays, on the new VCD, a screen (new VCD screen, input screen) including destination images of two mail items.

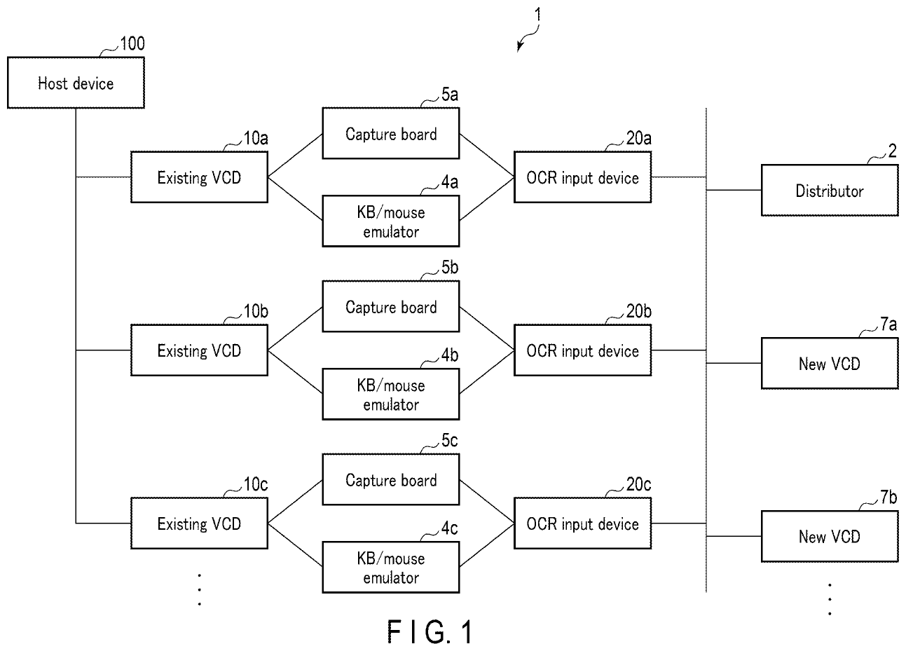

FIG. 1 shows a configuration example of an input system 1 according to the embodiment. As shown in FIG. 1, the input system 1 includes a distributor 2, a keyboard/mouse emulator 4, a capture board 5, a new VCD 7, an existing VCD 10, an OCR input device 20, a host device 100, and the like.

Here, the input system 1 includes keyboard/mouse emulators 4a to 4c as the keyboard/mouse emulator 4. The input system 1 includes capture boards 5a to 5c as the capture board 5. The input system 1 includes new VCDs 7a and 7b as the new VCD 7. The input system 1 includes existing VCDs 10a to 10c as the existing VCD 10. The input system 1 includes OCR input devices 20a to 20c as the OCR input device 20.

The host device 100 is connected to the existing VCDs 10a to 10c. The existing VCDs 10a to 10c are connected to the keyboard/mouse emulators 4a to 4c, and the capture boards 5a to 5c, respectively. The OCR input devices 20a to 20c are connected to the keyboard/mouse emulators 4a to 4c, and the capture boards 5a to 5c, respectively. The distributor 2 is connected to the new VCDs 7a and 7b and the OCR input devices 20a to 20c. The new VCDs 7a and 7b are connected to the OCR input devices 20a to 20c.

The input system 1 may include a configuration as needed in addition to the configuration shown in FIG. 1, or a specific configuration may be excluded from the input system 1.

The host device 100 supplies the destination image including the character string related to the destination to the existing VCD 10. The host device 100 acquires the character string included in the destination image from the existing VCD 10.

For example, the host device 100 is a sorter that sorts mail items or the like.

The host device 100 photographs a mail item using a camera or the like. The host device 100 performs OCR processing (primary OCR processing, first character recognition processing) on the image (destination image) obtained by photographing, and recognizes a character string described on the mail item.

If the OCR processing has failed, the host device 100 supplies the destination image for which the OCR processing has failed to the existing VCD 10. The host device 100 acquires the character string included in the destination image from the existing VCD 10.

The host device 100 sorts the mail item based on the character string acquired by the OCR processing or the character string acquired from the existing VCD 10.

The existing VCD 10 (external device) acquires the destination image from the host device 100. The existing VCD 10 transmits a screen (existing VCD screen) including the destination image to the OCR input device 20. The existing VCD screen may include destination images of two mail items or may include a destination image of a single mail item.

The existing VCD 10 acquires the character string included in the destination image from the OCR input device 20. The existing VCD 10 transmits the acquired character string to the host device 100. The existing VCD 10 will be described in detail later.

The keyboard/mouse emulator 4 emulates an operation terminal such as a keyboard or a mouse connected to the existing VCD 10. The keyboard/mouse emulator 4 supplies, to the existing VCD 10, the same operation signal as the operation signal input by the operator through the operation terminal under the control of the OCR input device 20. For example, the keyboard/mouse emulator 4 supplies, to the existing VCD 10, an operation signal indicating a movement or click of a mouse, an input of a keyboard, or the like.

Here, the keyboard/mouse emulators 4a to 4c respectively supply the operation signals to the existing VCDs 10a to 10c under the control of the OCR input devices 20a to 20c.

The capture board 5 acquires the existing VCD screen supplied by the existing VCD 10. The capture board 5 supplies the acquired existing VCD screen to the OCR input device 20.

Here, the capture boards 5a to 5c respectively acquire the existing VCD screens of the existing VCDs 10a to 10c and supply them to the OCR input device 20a to 20c.

The OCR input device 20 acquires the existing VCD screen from the capture board 5. The OCR input device 20 performs OCR processing (secondary OCR processing, second character recognition processing) on the acquired destination image. The OCR input device 20 recognizes a character string included in the destination image by the OCR processing. The OCR input device 20 supplies the recognized character string to the existing VCD 10 through the keyboard/mouse emulator 4.

Furthermore, if the OCR processing fails, the OCR input device 20 displays, on any one of the new VCDs 7, a screen (new VCD screen) for accepting input of a character string. The OCR input device 20 transmits a character string to be input to the new VCD 7 to the existing VCD 10 through the new VCD screen.

The OCR input device 20 will be described in detail later.

The distributor 2 selects the new VCD 7 for displaying the new VCD screen from the OCR input device 20.

For example, the distributor 2 transmits a control signal indicating a display destination of the new VCD screen to the OCR input device 20.

The new VCD 7 (input/output device) displays the new VCD screen and accepts input from the operator for a character string. The new VCD 7 supplies the input character string to the OCR input device 20. For example, the new VCD 7 supplies the input operation signal to the OCR input device 20.

For example, the new VCD 7 includes a display terminal such as a monitor for displaying the new VCD screen, and an operation terminal such as a mouse and a keyboard for accepting operation input. The new VCD 7 may include a display terminal and operation terminal connected to the OCR input device 20. The new VCD 7 may be a personal computer or the like.

Next, the existing VCD 10 will be described. The existing VCDs 10a to 10c have the same configuration, and thus will be described as the existing VCD 10.

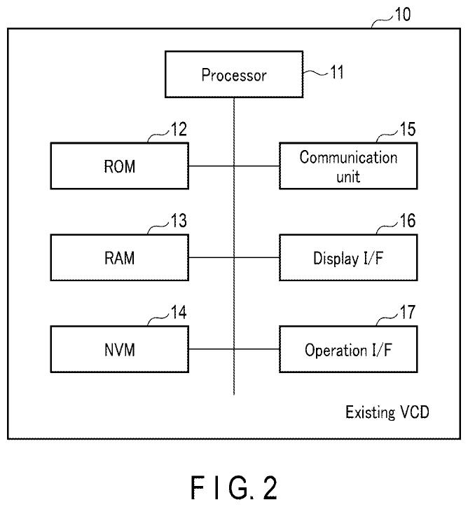

FIG. 2 shows a configuration example of the existing VCD 10 according to the embodiment. FIG. 2 is a block diagram showing a configuration example of the existing VCD 10. As shown in FIG. 2, the existing VCD 10 includes a processor 11, a ROM 12, a RAM 13, an NVM 14, a communication unit 15, a display interface 16, an operation interface 17, and the like.

The processor 11, the ROM 12, the RAM 13, the NVM 14, the communication unit 15, the display interface 16, and the operation interface 17 are connected to each other via a bus or the like.

The existing VCD 10 may include a configuration as needed in addition to the configuration illustrated in FIG. 2, or a specific configuration may be excluded from the existing VCD 10.

The processor 11 has a function of controlling the operation of the entire existing VCD 10. The processor 11 may include an internal cache, various interfaces, and the like. The processor 11 realizes various processes by executing programs stored in advance in the internal memory, the ROM 12, or the NVM 14.

Some of the various functions realized by the processor 11 executing the programs may be realized by a hardware circuit. In this case, the processor 11 controls the functions executed by the hardware circuit.

The ROM 12 is a nonvolatile memory in which a control program, control data and the like are stored in advance. The control program and the control program stored in the ROM 12 are incorporated in advance according to the specifications of the existing VCD 10.

The RAM 13 is a volatile memory. The RAM 13 temporarily stores data, etc. being processed by the processor 11. The RAM 13 stores various application programs based on instructions from the processor 11. The RAM 13 may store data necessary for executing the application program, an execution result of the application program, etc.

The NVM 14 is a data-writable and rewritable nonvolatile memory. For example, the NVM 14 is configured by an HDD, an SSD, a flash memory, or the like. The NVM 14 stores control programs, applications, and various kinds of data according to the operation purpose of the existing VCD 10.

The communication unit 15 is an interface for transmitting and receiving data to and from the host device 100. For example, the communication unit 15 is an interface that supports wired or wireless LAN connection.

The display interface 16 is an interface that transmits and receives data to and from the capture board 5. The display interface 16 transmits the existing VCD screen to the capture board 5 under the control of the processor 11.

The operation interface 17 is an interface for accepting input of an operation. For example, the operation interface 17 receives an operation signal indicating an operation input to an operation terminal such as a keyboard or a mouse. The operation interface 17 supplies the received operation signal to the processor 21. For example, the operation interface 17 supports Universal Serial Bus (USB) connection.

Here, the operation interface 17 is connected to the keyboard/mouse emulator 4. That is, the operation interface 17 receives an operation signal from the keyboard/mouse emulator 4.

For example, the existing VCD 10 is a desktop personal computer or a laptop personal computer.

The processor 11 of the existing VCD 10 acquires the destination image from the host device 100 through the communication unit 15. Upon acquiring the destination image, the processor 11 generates an existing VCD screen for accepting input for a destination appearing in the destination image. The existing VCD screen includes the acquired destination image.

Upon generating the existing VCD screen, the processor 11 outputs the generated existing VCD screen to the capture board 5 through the display interface 16.

Upon outputting the existing VCD screen, the processor 11 accepts input for the character string through the operation interface 17. That is, the processor 11 acquires a signal (an operation signal indicating a key input or the like) similar to that when the operation terminal is connected from the keyboard/mouse emulator 4 through the operation interface 17.

Upon receiving an operation signal for confirming the input (e.g., an operation signal indicating pressing of the enter key) through the operation interface 17, the processor 11 transmits the input character string to the host device 100 through the communication unit 15.

Next, the OCR input device 20 will be described. The OCR input devices 20a to 20c have the same configuration, and thus will be described as the OCR input device 20.

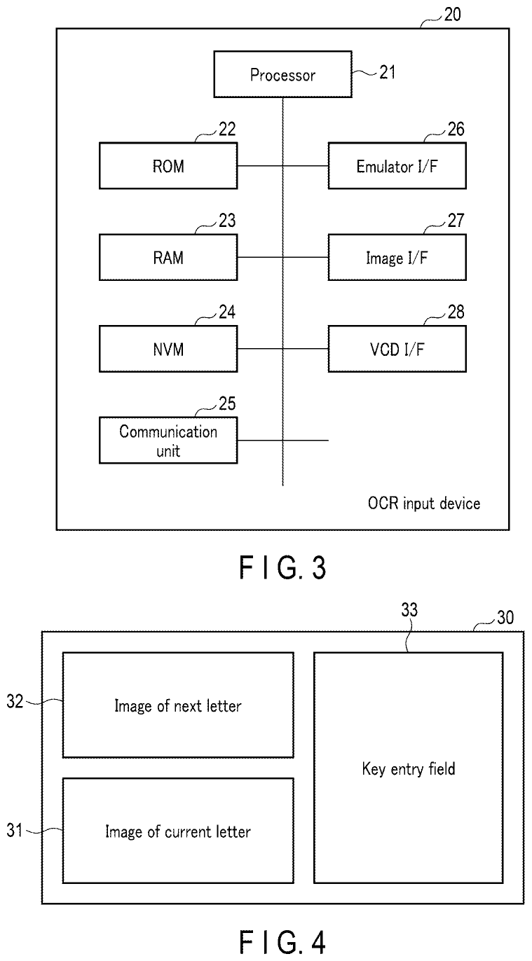

FIG. 3 shows a configuration example of the OCR input device 20 according to the embodiment. FIG. 3 is a block diagram illustrating a configuration example of the OCR input device 20. As shown in FIG. 3, the OCR input device 20 includes a processor 21, a ROM 22, a RAM 23, an NVM 24, a communication unit 25, an emulator interface 26, an image interface 27, a VCD interface 28, and the like.

The processor 21, the ROM 22, the RAM 23, the NVM 24, the emulator interface 26, the image interface 27, and the VCD interface 28 are connected to each other via a bus or the like.

The OCR input device 20 may include a configuration as needed in addition to the configuration illustrated in FIG. 3, or a specific configuration may be excluded from the OCR input device 20.

The processor 21 has a function of controlling the operation of the entire OCR input device 20. The processor 21 may include an internal cache, various interfaces, and the like. The processor 21 realizes various processes by executing programs stored in advance in the internal memory, the ROM 22, or the NVM 24.

Some of the various functions realized by the processor 21 executing the program may be realized by a hardware circuit. In this case, the processor 21 controls the functions executed by the hardware circuit.

The ROM 22 is a nonvolatile memory in which a control program, control data and the like are stored in advance. The control program and the control data stored in the ROM 22 are incorporated in advance according to the specifications of the OCR input device 20.

The RAM 23 is a volatile memory. The RAM 23 temporarily stores data, etc. being processed by the processor 21. The RAM 23 stores various application programs based on instructions from the processor 21. The RAM 23 may store data necessary for executing the application program, an execution result of the application program, etc.

The NVM 24 is a data-writable and rewritable nonvolatile memory. For example, the NVM 24 is configured by an HDD, an SSD, a flash memory, or the like. The NVM 24 stores control programs, applications, and various kinds of data according to the purpose of use of the OCR input device 20.

The communication unit 25 is an interface for transmitting and receiving data to and from the distributor 2, another OCR input device 20, and the like. For example, the communication unit 25 is an interface that supports wired or wireless LAN connection.

The emulator interface 26 (input interface) is an interface that transmits and receives data to and from the keyboard/mouse emulator 4. The emulator interface 26 causes the keyboard/mouse emulator 4 to output an operation signal to the existing VCD 10 under the control of the processor 21. For example, the emulator interface 26 supports USB connection.

The image interface 27 is an interface that transmits and receives data to and from the capture board 5. The image interface 27 acquires the existing VCD screen from the capture board 5. The image interface 27 supplies the acquired existing VCD screen to the processor 21.

The VCD interface 28 (input/output interface) is an interface that transmits and receives data to and from the new VCD 7. The VCD interface 28 displays information on the new VCD 7 under the control of the processor 21. The VCD interface 28 receives an operation signal indicating an operation input to the new VCD 7. The VCD interface 28 supplies the received operation signal to the processor 21.

For example, the OCR input device 20 is a desktop personal computer or a laptop personal computer. The emulator interface 26, the image interface 27, and the VCD interface 28 (or some of them) may be integrally formed.

Next, functions realized by the OCR input device 20 will be described. The functions realized by the OCR input device 20 are realized by the processor 21 executing a program stored in the ROM 22, the NVM 24, or the like.

First, the processor 21 has a function of acquiring the existing VCD screen supplied by the existing VCD 10.

That is, the processor 21 acquires the existing VCD screen displayed on a display terminal (display or the like) connected to the display interface 16 by the existing VCD 10.

For example, the processor 21 acquires the existing VCD screen from the existing VCD 10 connected to itself. The processor 21 acquires the existing VCD screen from the capture board 5 through the image interface 27. That is, the capture board 5 acquires the existing VCD screen under the control of the processor 21. The capture board 5 supplies the acquired existing VCD screen to the processor 21 through the image interface 27.

For example, the processor 21 acquires the existing VCD screen at a predetermined interval (e.g., one second). The processor 21 may acquire the existing VCD screen when a change has occurred in the existing VCD screen. In this case, the processor 21 may determine whether a change has occurred in the existing VCD screen according to an image processing algorithm or the like.

The processor 21 has a function of recognizing the character string related to the destination from the existing VCD screen by the OCR processing.

Upon acquiring the existing VCD screen, the processor 21 extracts a destination image from the existing

VCD screen in accordance with a format acquired in advance or the like.

Upon extracting the destination image, the processor 21 performs OCR processing on the destination image in accordance with a predetermined algorithm. Here, the processor 21 recognizes a postal code, a district, and an apartment building name in order as character strings (items) related to the destination.

The processor 21 may perform predetermined processing on the existing VCD screen or the destination image before performing the OCR processing. For example, the processor 21 may enlarge or reduce the existing VCD screen or the destination image. The processor 21 may perform processing of removing noise on the existing VCD screen or the destination image.

Upon performing the OCR processing, the processor 21 recognizes the character string related to the destination.

The processor 21 has a function of transmitting the character string recognized by the OCR processing to the existing VCD 10 by using the keyboard/mouse emulator 4.

Upon recognizing the character string by the OCR processing, the processor 21 transmits the recognized character string to the operation interface 17 of the existing VCD 10 by using the keyboard/mouse emulator 4. That is, the processor 21 transmits an operation signal for inputting a key corresponding to the recognized character string to the operation interface 17.

The processor 21 may input an operation signal indicating an operation of completing the input of the character string to the operation interface 17.

The processor 21 has a function of accepting input from the operator for the character string included in the destination image.

Here, it is assumed that the processor 21 recognizes a postal code, a district, and an apartment building name in order and the OCR processing fails in the middle. It is assumed that the processor 21 does not perform OCR processing on an item for which OCR processing has failed and items subsequent thereto.

When the OCR processing has failed, the processor 21 generates a new VCD screen for accepting input of the character string. As described above, the new VCD screen includes two destination images for which the OCR processing has failed. That is, the new VCD screen includes a destination image to which the operator inputs a character string (an image of a current letter), and a destination image to which the operator inputs a character string next (an image of a next letter).

FIG. 4 shows an example of a new VCD screen 30. As shown in FIG. 4, the new VCD screen 30 includes a first display area 31, a second display area 32, a key entry field 33, and the like.

The first display area 31 is formed at the lower left of the new VCD screen 30. The first display area 31 displays the image of the current letter.

The second display area 32 is formed at the upper left of the new VCD screen 30. The second display area 32 displays the image of the next letter.

The key entry field 33 is formed on the right side of the new VCD screen 30. The key entry field 33 is an input field for accepting input from the operator for a character string (item) included in the image of the original letter displayed in the first display area.

The processor 21 displays, on the new VCD screen 30, item information indicating an item (input item) for which input is accepted for each destination image.

First, the processor 21 sets an input item for the destination image.

Here, the processor 21 sets an input item based on a result of the OCR processing on the destination image. For example, the processor 21 sets an item for which the OCR processing has failed as an input item.

For example, if the OCR processing on a postal code has failed in the destination image, the processor 21 sets a postal code (that is, a postal code and items subsequent thereto) as an input item of the destination image. In this case, the processor 21 accepts input from the operator for the postal code and items subsequent thereto.

If the OCR processing on a district in the destination image has failed, the processor 21 sets a district (that is, a district and items subsequent thereto) as an input item of the destination image. In this case, the processor 21 accepts input from the operator for the district and items subsequent thereto.

If the OCR processing on an apartment building name has failed in the destination image, the processor 21 sets an apartment building name as an input item of the destination image. In this case, the processor 21 accepts input from the operator for the apartment building name.

The processor 21 may accept input from the operator for a character string even if the OCR processing is successful. For example, if a person who has moved to another place is present in an apartment building or the like, the processor 21 accepts input for the name of the person who has moved to another place included in the destination image. In this case, the processor 21 sets the person's name as an input item of the destination image.

Upon setting the input item in each destination image, the processor 21 displays item information indicating the input item on the new VCD screen 30. Here, the processor 21 adds the item information to each of the destination images (the image of the current letter and the image of the next letter).

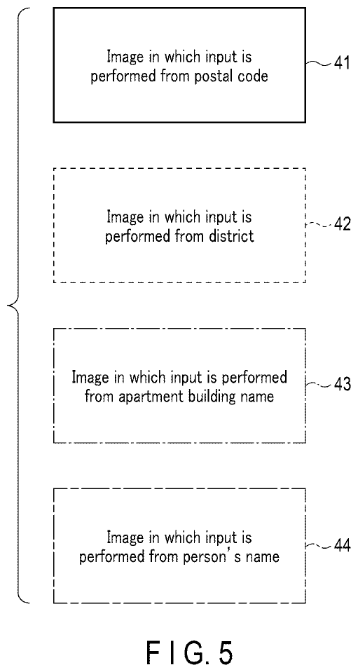

FIG. 5 shows an example of a destination image to which item information is added. FIG. 5 shows four examples.

The item information is a frame surrounding the destination image. The item information indicates the input item by a color of a line constituting the frame.

For example, item information 41 is a black frame. The item information 41 indicates a postal code as an input item.

Item information 42 is a blue frame. The item information indicates a district as an input item.

Item information 43 is a red frame. The item information indicates an apartment building name as an input item.

Item information 44 is a purple frame. The item information indicates a person's name as an input item.

The processor 21 displays, in the first display area, the image of the current letter and the item information (frame) corresponding to the image of the current letter. The processor 21 displays, in the second display area, the image of the next letter and the item information (frame) corresponding to the image of the current letter.

Upon generating the new VCD screen 30, the processor 21 displays the generated new VCD screen 30 on one of the new VCDs 7. Upon displaying the new VCD screen 30 on the new VCD 7, the processor 21 accepts input to the key entry field 33 of the new VCD screen 30 through the new VCD 7.

Here, the operator visually checks the image of the current letter, and inputs a character string related to the input item in the key entry field 33 of the new VCD screen 30. Upon completing the input of the character string, the operator inputs an operation of completing the input to the new VCD 7.

The processor 21 transmits the input character string to the existing VCD 10. That is, the processor 21 receives an operation signal indicating a key input to the new VCD 7 through the VCD interface 28. The processor 21 transmits an operation signal for inputting the key to the operation interface 17 of the existing VCD 10 by using the keyboard/mouse emulator 4.

Next, an operation example of the OCR input device 20 will be described.

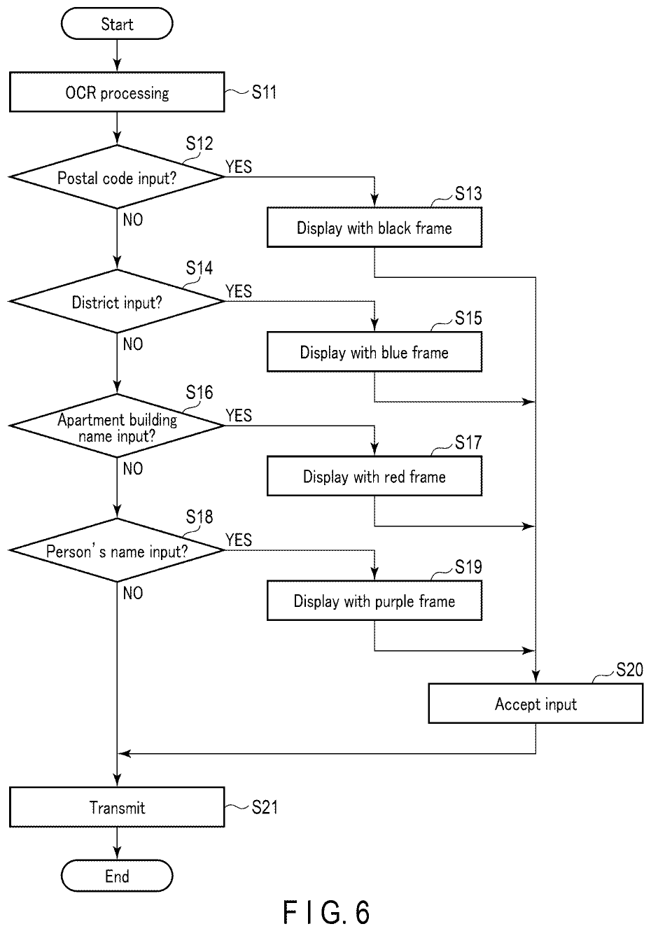

FIG. 6 is a flowchart for explaining an operation example of the OCR input device 20.

First, the processor 21 of the OCR input device 20 performs OCR processing on the destination image (S11).

Upon performing the OCR processing, the processor 21 determines whether or not a postal code is set as an input item of the destination image (S12). Upon determining that the postal code is set as an input item of the destination image (S12, YES), the processor 21 displays the destination image with a black frame on the new VCD screen 30 (S13).

Upon determining that the postal code is not set as an input item of the destination image (S12, NO), the processor 21 determines whether or not a district is set as an input item of the destination image (S14). Upon determining that the district is set as an input item of the destination image (S14, YES), the processor 21 displays the destination image with a blue frame on the new VCD screen 30 (S15).

Upon determining that the district is not set as an input item of the destination image (S14, NO), the processor 21 determines whether or not an apartment building name is set as an input item of the destination image (S16). Upon determining that the apartment building name is set (S16, YES), the processor 21 displays the destination image with a red frame on the new VCD screen 30 (S17).

Upon determining that the apartment building name is not set as an input item of the destination image (S16, NO), the processor 21 determines whether or not a person's name is set as an input item of the destination image (S18). Upon determining that the person's name is set as an input item of the destination image (S18, YES), the processor 21 displays the destination image with a purple frame on the new VCD screen 30 (S19).

When the destination image is displayed with a black frame (S13), the destination image is displayed with a blue frame (S15), the destination image is displayed with a red frame (S17), or the destination image is displayed with a purple frame (S19), the processor 21 accepts input from the operator for a character string through the new VCD 7 (S20).

If it is determined that the person's name is not set as an input item of the destination image (S18, NO), or input from the operator for a character string is accepted (S20), the processor 21 transmits the character string acquired by the OCR processing or the character string input from the operator to the existing VCD 10 through the emulator interface 26 (S21).

Upon transmitting the character string to the existing VCD 10, the processor 21 ends the operation.

The processor 21 may generate the new VCD screen 30 and accept input for the character string upon executing S11 to S19 on the image of the current letter and the image of the next letter.

The new VCD screen 30 and the existing VCD screen may have the same configuration or different configurations.

The new VCD screen 30 may display one destination image (image of the current letter) and item information corresponding to the destination image. The new VCD screen 30 may display three or more destination images and item information corresponding to the destination images.

The item information may indicate an input item by a line constituting the frame. For example, the item information may indicate the input item by a solid line, a broken line, a one-dot chain line, a two-dot chain line, or the like. The item information may be a mark, a symbol, a numerical number, a character string, or a combination thereof. The configuration of the item information is not limited to a specific configuration.

The processor 21 of the OCR input device 20 may recognize the postal code from the destination image by OCR processing. In this case, when the OCR processing fails, the processor 21 sets the postal code as an input item of the destination image. The processor 21 may set a person's name as an input item of the destination image based on the recognition result.

The processor 21 may continue the OCR processing even if the OCR processing fails in the middle of processing. In this case, the processor 21 may set an item for which the OCR processing has failed as an input item of the destination image.

The processor 21 may recognize, by OCR processing, a character string (e.g., an email address, a telephone number, etc.) other than the character string related to the destination. In this case, the processor 21 accepts input from the operator for a character string other than the character string related to the destination. The character string for which the processor 21 accepts input is not limited to a specific configuration.

The OCR input device 20 and the new VCD 7 may be integrally formed.

The distributor 2 may be integrally formed with any one of the OCR input devices 20.

The OCR input device 20 does not necessarily have to perform OCR processing on the destination image for which the primary OCR processing has failed. That is, the OCR input device 20 may perform the primary OCR processing.

The input system configured as described above can present, to the operator, an input item for which input is accepted. As a result, the input system can prevent reduction in typing efficiency of the operator.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A system comprising:
an image interface configured to acquire a character string image including a character string;
an input/output interface connected to an input/output device configured to display an image and accept input of an operation; and
a processor configured to:
perform character recognition processing on the character string image;
set an item, for which input is accepted, related to the character string based on a result of the character recognition processing;
display an input screen including the character string image and item information indicating the item on the input/output device through the input/output interface; and
accept input of the item through the input/output interface.

2. A system comprising:
an image interface configured to acquire, from an external device, a character string image for which first character recognition processing for a character string image including a character string has failed;
an input interface configured to input an operation signal to the external device;
an input/output interface connected to an input/output device configured to display an image and accept input of an operation; and
a processor configured to:
perform second character recognition processing on the character string image;
set an item, for which input is accepted, related to the character string based on a result of the second character recognition processing;
display an input screen including the character string image and item information indicating the item on the input/output device through the input/output interface;
accept input of the item through the input/output interface; and
transmit an input character string to the external device through the input interface.

3. The system according to claim 1, wherein the item information is a frame surrounding the character string image.

4. The system according to claim 2, wherein the item information is a frame surrounding the character string image.

5. The system according to claim 3, wherein the item information indicates the item by a color of a line constituting the frame.

6. The system according to claim 4, wherein the item information indicates the item by a color of a line constituting the frame.

7. The system according to claim 1, wherein the input screen includes two of the character string images and the item information corresponding respectively to the character string images.

8. The system according to claim 2, wherein the input screen includes two of the character string images and the item information corresponding respectively to the character string images.

9. The system according to claim 1, wherein the item is an item related to a destination.

10. The system according to claim 2, wherein the item is an item related to a destination.

11. The system according to claim 9, wherein the item includes any one of a postal code, a district, an apartment building name, or a person's name.

12. The system according to claim 10, wherein the item includes any one of a postal code, a district, an apartment building name, or a person's name.

13. The system according to claim 1, comprising the input/output device.

14. The system according to claim 2, comprising the input/output device.

15. The system according to claim 2, wherein the input interface is connected to an emulator configured to emulate an operation terminal.

16. An information processing method executed by a processor, the method comprising:
acquiring a character string image including a character string;
performing character recognition processing on the character string image;
setting an item, for which input is accepted, related to the character string based on a result of the character recognition processing;
displaying, on an input/output device, an input screen including the character string image and item information indicating the item; and
accepting input of the item through the input/output device.
